(19) United States
(12) Patent Application Publication
(10) Pub. No.: US 2010/0297506 A1
(43) Pub. Date: Nov. 25, 2010

(54) TETRABASIC LEAD OXIDE AND LEAD MONOXIDE COMPOSITION TO BE USED IN LEAD-ACID BATTERIES AND IT'S METHOD OF PRODUCTION

(76) Inventor: Enver Karabacak, Izmir (TR)

Correspondence Address: AMSTER, ROTHSTEIN & EBENSTEIN LLP, 90 PARK AVENUE, NEW YORK, NY, 10016, US

(21) Appl. No.: 12/864,499

(22) PCT Filed: Jan. 26, 2009
(86) PCT No.: PCT/TR2009/000011

§ 371 Date: Aug. 10, 2010

(30) Foreign Application Priority Data
Jan. 25, 2008 (TR) 2008/00525

(51) Int. Cl. H01M 4/66; H01M 4/88

(52) U.S. Cl. 429/245; 252/182.1

(57) ABSTRACT

This invention relates to a new battery oxide mixture for use in lead acid batteries and/or battery plates, specifically tetrabasic lead sulphate and lead oxide mixture that is derived through basic reactions from lead sulphate and the method utilized to obtain the said tetrabasic lead sulphate and lead oxide mixture by basic reactions starting by lead sulphate as initial substance. Additionally, this invention relates to battery plates produced wherein the paste made of tetrabasic lead sulphate and lead oxide mixture is plastered on lead battery grids.

### 1. FIELD OF THE INVENTION

This invention relates to a new battery oxide mixture, specifically tetrabasic lead sulphate (TTBLS) and lead oxide that is derived through basic reactions from lead sulphate and the method utilized to obtain the said tetrabasic lead sulphate and, lead oxide mixture by basic reactions starting by lead sulphate as initial substance. Additionally, this invention relates to battery plates produced wherein the paste made of tetrabasic lead sulphate and lead oxide mixture is plastered on lead battery grids.

### 2. THE OBJECT OF THE INVENTION AND THE PRIOR ART

In the prior art for a considerable period of time now, the initial substance being used in battery industry is the battery oxide that consists of lead monoxide with some small percentage of metallic lead seeds. Battery oxide is mixed with sulphuric acid to form a paste and the plastered battery plates are subsequently cured the objective of this procedure being to increase the mechanical and electrical quality of plates by forming tetrabasic lead sulphate crystals inside the paste. In recent years an alternative application is being utilized to achieve this objective, namely that TTBLS crystals are being added as seeds to an appropriate percentage directly into the paste of battery oxide to initialize rapid growth of similar crystals.

However, these applications are not sufficient to promote faster production, better overall electrical quality and longer battery life. This invention enables production of TTBLS and lead oxide in the same reaction process and at an appropriate proportion. The composition obtained by the subject method of this invention with its perfect homogenous structure, has all the advantages of conventional battery oxide with TTBLS added into it afterwards. Thus by the use of the tetrabasic lead sulphate and lead oxide mixture derived from lead sulphate through basic reactions that is the subject matter of this invention, a much more rapid production of batteries, a much better overall efficiency and much longer battery life is made possible over the state of the art techniques.

### 3. DETAILED EXPLANATION OF THE PREFERRED EMBODIMENTS

Stoichiometric equivalents of lead sulphate and aqueous sodium hydroxide are set into the reaction with a volume that is 7-15 times of reactants, in order to form tribasic lead sulphate at a temperature between 0°-50° C. In a reactor with a mixing apparatus lead sulphate is set to react with sodium hydroxide that is the stoichiometric equivalent of lead sulphate plus enough to bring the solution formed to pH 12-14. The medium temperature should be between 0°-50° C. and water amount 7-15 times of lead sulphate.

Tribasic lead sulphate is separated from the solution by any known method like iterative washing and/or centrifugal devices. The typical chemical equations of the reaction explained above and of the next step are as follows:

60PbSO₄₍ₛ₎+90NaOH_{(aq)}→15(3PbO*PbSO₄)₍ₛ₎+45Na₂SO_{4(aq)}+45H₂O_{(aq)} (1)

15(3PbO*PbSO₄)₍ₛ₎+6NaOH_{(aq)}→12(4PbO*PbSO₄)₍ₛ₎+3Na₂SO_{4(aq)}+3H₂O_{(aq)} (2)

As the next step, in a similar reactor, tribasic lead sulphate, 3-6 times water and stoichiometric equivalent of sodium hydroxide go into reaction to form tetrabasic lead sulphate. The temperature of the reaction is kept between 40° to 100° C. and pH is maintained in the range 10 to 13. Under these conditions, stirring continues until reaction reaches equilibrium. (Equation No. 2)

In the final step, following the same conditions as before, additional sodium hydroxide is added according to the equation: 12(4PbO*PbSO4)₍ₛ₎+2NaOH_{(aq)}→11{(4PbO*PbSO₄)₍ₛ₎+5PbO₍ₛ₎}+Na₂SO4_{(aq)}+H₂O_{(aq)}(3) to form the tetrabasic lead sulphate and lead oxide mixture.

The equation {4PbO*PbSO4+5PbO} given here as an example has a specific mixture ratio of the tetrabasic lead sulphate and lead oxide mixture desired. This mixture may be altered, as can be seen in the equation (3) to match the required needs by changing the amount of sodium hydroxide.

As a summary, tribasic lead sulphate is put into reaction with stoichiometric equivalent of sodium hydroxide in aqueous medium to form tetrabasic lead sulphate as suspension in which the resultant solution, main solute being sodium sulphate, is approximately 7 to 15 times the volume of overall reactants at temperatures 40°-100° C. To this medium, if found necessary, a pre-calculated amount of sodium hydroxide can be added so as to form the tetrabasic lead sulphate and lead monoxide mixture. After adding appropriate amount of sodium hydroxide to obtain desired tetrabasic lead sulphate and lead monoxide mixture, mixing in the reactor is retained, with same medium conditions until equilibrium is reached.

The solid part of the suspension is separated from the solution, consisting of sodiumsulphate and water, and is dried. The solution is taken off after the solid material has settled down. And, if a change in physical properties is necessary, it is heated up to 40°-800° C. for drying. The mixture is finally milled to sizes 1-10 microns as considered suitable to be used as a battery paste or accordingly for other purposes.

To prepare battery paste, water and/or 5° to 40° Borne sulphuric acid is added to the mixture and the amount of acid to be added to the mixture is 10% to 20%, which makes it suitable for plastering. Paste is then plastered onto the lead grids thus producing battery plates. The battery plates plastered using the procedure explained above should be cured in a very humid medium at 30° to 100° C. for the duration of 3 to 14 hours depending on the ratio of the mixture used. The cured plates are then ready to proceed on to battery production.

The tetrabasic lead sulphate and lead monoxide mixture, production of which is described above, demonstrates all the benefits of the conventional system of adding tetrabasic lead sulphate directly into battery oxide in the production line but in a perfectly homogenous state. The tetrabasic lead sulphate and lead monoxide mixture described above is not limited in use only with respect to the procedure explained above. It can also be mixed to an appropriate degree with conventional battery oxide and altogether processed into battery paste.

1-12. (canceled)

13. A process for the production of a battery oxide admixture for use in lead acid batteries and/or battery plates characterized in that the process comprises reacting the stoichiometric equivalents of lead sulphate and aqueous sodium hydroxide at a temperature between 0°-50° C. in order to form tribasic lead sulphate and reacting said tribasic lead sulphate with sodium hydroxide that is the stoichiometric equivalent of tribasic lead sulphate at a temperature between 40° to 100° C. to obtain tetrabasic lead sulphate.

14. A process for the production of a battery oxide admixture for use in lead acid batteries and/or battery plates according to claim 13, characterized in that the tetrabasic lead sulphate is set into reaction with additional sodium hydroxide at between 40° to 100° C. to form the tetrabasic lead sulphate and lead oxide mixture that contain preferred ratio of lead oxide.

15. A process for the production of a battery oxide admixture for use in lead acid batteries and/or battery plates according to claim 14, characterized in that the tetrabasic lead sulphate and the lead oxide mixture is subsequently milled to sizes 1μ-10μ.

16. A process for the production of a battery oxide admixture for use in lead acid batteries and/or battery plates according to claim 15, characterized in that the milled mixture is used independently or after being mixed with a conventional battery oxide at a preferred ratio.

17. A process for the production of a battery oxide admixture for use in lead acid batteries and/or battery plates according to claim 16, characterized in that tetrabasic lead sulphate and lead oxide mixture arranged in the preferred ratio is mixed with battery oxide and afterwards water and/or 5° to 40° Baume sulphuric acid is added to obtain the battery paste suitable for plastering.

18. A battery plate containing the battery lead grids characterized in that the battery plate is obtained by coating the paste according to claim 17.

19. A battery plate according to claim 18, characterized by wherein a plastered battery plates are cured in a very humid medium at 30° to 100° C. for the duration of 3 to 14 hours.

20. A battery, characterized by being produced by using the battery plates according to claim 19.

21. Battery oxide mixture for use in lead acid batteries and/or battery plates manufactured by the process of claim 13.
